(19) United States
(12) Patent Application Publication
(10) Pub. No.: US 2002/0089673 A1
(43) Pub. Date: Jul. 11, 2002

(54) 3-D measurements of improved accuracy

(76) Inventor: Tilo Lilienblum, Magdeburg (DE)

Correspondence Address: Law Offices of Karl Hormann, 86 Sparks Street, Cambridge, MA, 02138-2216, US

(21) Appl. No.: 10/035,469

(22) Filed: Dec. 28, 2001

(30) Foreign Application Priority Data
Dec. 28, 2000 (DE) DE100 65 121.6-52

(51) Int. Cl. G01B 11/24

(52) U.S. Cl. 356/602

(57) ABSTRACT

A method of improving the accuracy of optical 3-D measuring method utilizing a matrix camera provided with an image recording matrix of known pixel raster width of pitch for generating an image by measuring for all pixels or a selected portion thereof the individual deviation of the pixel site relative to a desired position for determining on the basis thereof the individual exact pixel sites and taking them into consideration for the calculation of the 3-D data.

### BACKGROUND OF THE INVENTION

1. Field of the Invention

The invention, in general, relates to a method of improving the accuracy of optical three-dimensional measuring methods and, more particularly, to a method of this kind utilizing a matrix camera for generating an image.

2. The Prior Art

Such cameras are equipped with image recording matrices which are capable of detecting the intensity distribution of an image in a pixel-wise manner and of emitting it as a matrix. They may be exemplified by CCD sensors and CMOS sensors provided in cameras. An individual element of the image recording matrix is called pixel. The position of the pixels of an image recording matrix will hereinafter be referred to as a “pixel site”, the pixel site being represented by the position of the center of the pixel.

Calculation of the three-dimensional data of an object on the basis of digital images thereof is performed by known methods of stereophotogrammetry by sub-pixel interpolation. Such a method has been described in German patent specification DE 196 23 172 C1 (U. S. Pat. No. ______). Sub-pixel interpolation is the calculation of the precise position of a dot based on the values of neighboring pixels. The sub-pixel position is more precise than the pixel raster. 4(2×2), 9(3×3), 16(4×4) of more pixels may be used for the sub-pixel formulation.

In an ideal image recording matrix the pixel sites are arranged in an ideal pixel raster of constant raster width. The pixel sites of such an ideal image recording matrix are ideal pixel sites; their position is called “desired position”.

For purposes of taking into consideration fabrication-inherent deviations of the actual pixel raster from an ideal pixel raster it is known to take measurements of a reference measure. For instance, the distance between two points may be measured by defining the centers of the two points. For the definition of each center several pixels will become involved. In this manner, a possible error may be averaged out. The mean distance between the pixels may thus be defined with great accuracy since the overall error remains unchanged and the relative error becomes smaller at a corresponding number of pixels.

Such deviations of the actual pixel raster are usually taken into consideration during calibration of a three-dimensional measuring system (Luhmann, T. : Nahbereichsphotogrammetrie; Wichmann Verlag, Heidelberg).

Comparative tests with high-resolution three-dimensional measuring systems have shown that 3-D data obtained by two identically configured 3-D measuring systems, the image recording matrices of which come from the same fabrication series, always display slight deviations which cannot be traced to known effects such as non-uniform photo sensitivity or dark signals of the image recording matrix.

It has been found that the accuracy of optical three-dimensional measuring systems which for generating an image utilize at least one matrix camera with an image recording matrix whose raster width of the pixel raster is known, is improved by measuring, for all pixels or a selected partial number of pixels of the image recording matrix, the individual deviation of the pixel site relative to the desired position of the pixel site in the pixel raster, by determining the exact individual pixel sites on the basis thereof and by taking these exact pixel sites into consideration when calculating the 3-D data.

While it is possible to define the individual deviation of the pixel site relative to the desired position of the pixel site by scanning the image recording matrix by a laser, the expense and complexity of laser scanning equipment for scanning an image recording matrix are unacceptably high.

### OBJECTS OF THE INVENTION

It is an object of the invention, for defining deviations from the desired position of the pixel sites of pixels of at least one image recording matrix to make use of the method proposed in co-pending U.S. patent application Ser. No. ______ filed on even date herewith (Attorney Docket 010501) wherein the image recording matrix becomes a component of an optical 3-D measuring system at least while the method is being practiced.

### SUMMARY OF THE INVENTION

In the accomplishment of this and other objects the invention provides a method comprising the steps of:

a) making available an object which is suitable for measuring by the optical 3-D measuring system, the object being planar or of such curvature that during smoothing according to step c) only local errors in the 3-D data are averaged out without altering the contours of the object;

(Local errors are understood to be such errors as statistical uncertainty. This error excludes itself from the global error in particular, i.e. the absolute error of the measured 3-D coordinates relative to the world coordinate system.)

b) measuring the object by the 3-D measuring system for determining 3-D data of the object;

c) thereafter smoothing the determined 3-D data;

d) projecting back to the sensors of the at least one matrix camera all 3-D measurement points of the object by use of the 3-D data determined in step b) as well as those smoothed in step c);

e) determining the difference between the position of the two points associated with a 3-D measuring point and projected back to the sensors;

f) thereafter optionally shifting or not shifting between object and optical 3-D measuring system;

g) repeating steps b) through f) until the desired exactness of the deviations of the pixel site of the pixels of an image recording matrix to be determined by the method has been attained, the exactness being a function of the number of repetitions and number of shifts of step f); and

h) defining the deviation of the pixel site of the pixels from the desired position on the basis of the values for each pixel or selected pixels determined in step e).

It is possible by the method in accordance with the invention while defining the 3-D data of the measured object to take into consideration those deviations of the pixel site of an image recording matrix which could not be considered by calibration of the 3-D measuring system. In this manner, the accuracy of the 3-D data may be improved.

Other objects will in part appear hereinafter and will in part be obvious.

### DESCRIPTION OF THE DRAWING

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawing which depicts the effect of an error of the pixel site of a camera on the result of a measurement.

### DETAILED DESCRIPTION OF THE PREFERRED EMBODIMENT

The optical 3-D measuring method exemplarily chosen in connection with an embodiment is the method described in German patent application No.: DE 196 23 172 (U. S. Pat. No. ______). However, practicing the method of the invention makes it possible to modify other optical 3-D measuring methods for yielding improved accuracy.

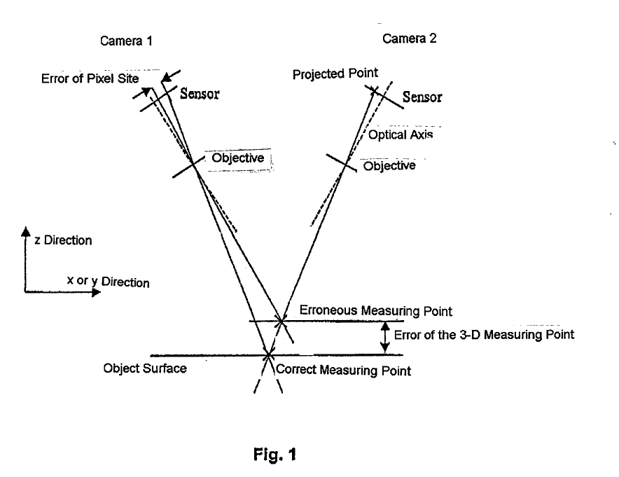

Measuring points defined by this 3-D measuring method will suffer from errors as a result of erroneous pixel sites. FIG. 1 is a view from the direction of the Y axis to an XZ plane. Accordingly, only one error of the pixel site is illustrated in the X or Z direction of this world coordinate system. Analogous connections will result for a view from the X direction to the YZ plane.

In German patent application DE 196 23 172 (U. S. Pat. No. ______) grey value sequences from two cameras are correlated with each other. This involves a search for corresponding points. The criterion for two corresponding points is a maximum correlation between two grey value sequences. The grey values for a predetermined point at a certain position in the image recording matrix are defined by sub-pixel interpolation.

If exact pixel sites are not available the described method of sub-pixel interpolation will yield an error.

In order to compensate the measurement error resulting from the error at the pixel site the equations for the sub-pixel interpolation will be modified such that the exact pixel site is also taken into consideration. In this manner the source of the error caused by the error of the pixel sites is eliminated.

The exact individual pixel sites may, for instance, be defined by a laser scanning process or by the method in accordance with copending application Ser. No.: ______(Attorney Docket 010501) described supra. In this connection, it is important that the object used for detecting the exact pixel sites be a planar object or an object of such curvature in which by smoothing the detected 3-D data of the object only the errors of the 3-D data are averaged out without altering the contours of the object.

What is claimed is:

1. A method of improving the accuracy of optical 3-D measuring methods of the kind which for generating an image utilize at least one matrix camera with an image recording matrix the raster width of the pixel raster of which is known, characterized by the steps of:
a) measuring the individual deviation of the pixel site relative to a desired pixel site position in the pixel raster;
b) determining from the measured deviation the individual exact pixel sites; and
c) taking the exact pixel sites into consideration when calculating the 3-D data.
